(19) United States
(12) Patent Application Publication
(10) Pub. No.: US 2025/0343373 A1
(43) Pub. Date: Nov. 6, 2025

(54) Omni-Directional Charging Interface for Wearable Computing Device

(71) Applicant: Google LLC, Mountain View, CA (US)

(72) Inventors: Jens Mitchell Nielsen, San Francisco, CA (US); Peter Michael Cazalet, Los Gatos, CA (US)

(21) Appl. No.: 18/866,434

(22) PCT Filed: Jun. 15, 2022
(86) PCT No.: PCT/US2022/033642

§ 371 Date: Nov. 15, 2024

(51) Int. Cl. H01R 13/62; G04C 10/00; G04G 17/06; H01R 13/22; H02J 7/00

(52) U.S. Cl. CPC H01R 13/6205; G04C 10/00; G04G 17/06; H01R 13/22; H02J 7/0044

(57) ABSTRACT

A charging interface (300) for a wearable computing device such as a smart watch is described herein. The charging interface can include a housing having an exterior surface (310) and an electrical contact (315) that is flush with the exterior surface. The charging interface can also include a magnet (325) disposed within the housing, the magnet co-axially aligned with the electrical contact along an axis (320), wherein a magnetic field of the magnet is configured to co-axially align an external charging pad (shown in dotted lines) with the electrical contact along the axis.

### FIELD

The present disclosure relates generally to wearable computing devices. More particularly, the present disclosure relates to omni-directional charging interfaces for wearable computing devices.

### BACKGROUND

Smart wearable computing devices, such as smart watches, can include charging interfaces for charging a battery of the smart wearable. Current solutions can either be inductive charging solutions or wired charging solutions. In wired charging solutions, electrical contacts of the charging interface come into contact with electrical contacts of a charging pad, which provides electrical charge to the smart wearable (among other functionality, such as providing contacts for other electrical sensor components).

Current wired charging solutions typically include electrical contacts located in charging recesses. These contacts generally confine the wearable to being orientated in only one or two defined directions when contacting the charging pad in order to interface with the electrical contacts located in the recesses. Furthermore, the recesses can collect non-hygienic detritus, which can hinder charging operations and generally is undesirable for maintaining hygiene for the charging interface, which regularly contacts the skin of the user while the user is wearing the smart wearable.

### SUMMARY

Aspects and advantages of embodiments of the present disclosure will be set forth in part in the following description, or can be learned from the description, or can be learned through practice of the embodiments.

In one embodiment, a charging interface for a wearable computing device can be provided. The charging interface can include a housing having an exterior surface and an electrical contact that is flush with the exterior surface. The charging interface can also include a magnet disposed within the housing, the magnet co-axially aligned with the electrical contact along an axis, wherein a magnetic field of the magnet is configured to co-axially align an external charging pad with the electrical contact along the axis.

In another embodiment, a wearable computing device can be provided. The wearable computing device can include a charging interface. The charging interface can include a housing having an exterior surface and an electrical contact that is flush with the exterior surface. The charging interface can also include a magnet disposed within the housing, the magnet co-axially aligned with the electrical contact along an axis, wherein a magnetic field of the magnet is configured to co-axially align an external charging pad with the electrical contact along the axis.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a wearable computing device according to some implementations of the present disclosure.

FIG. 2 depicts a wearable computing device positioned on an external charging pad according to some implementations of the present disclosure.

FIG. 3A depicts a charging interface according to an implementation of the present disclosure.

FIG. 3B depicts a charging interface according to another implementation of the present disclosure.

FIG. 3C depicts a charging interface according to yet another implementation of the present disclosure.

FIG. 4A depicts an electrical contact of a charging interface positioned at a center of an exterior surface of a housing of the charging interface according to an implementation of the present disclosure.

FIG. 4B depicts an electrical contact of a charging interface offset from a center of an exterior surface of a housing of the charging interface according to another implementation of the present disclosure.

FIG. 4C depicts an electrical contact of a charging interface positioned at a center of an exterior surface of a housing of the charging interface for a small form factor smart wearable according to an implementation of the present disclosure.

FIG. 5A depicts a charging footprint for a charging interface having an electrical contact positioned at a center of an exterior surface of a housing of the charging interface according to some implementations of the present disclosure.

FIG. 5B depicts a charging footprint for a charging interface having an electrical contact positioned offset from a center of an exterior surface of a housing of the charging interface according to an implementation of the present disclosure according to some implementations of the present disclosure.

FIG. 5C depicts a charging footprint for a charging interface having an electrical contact positioned at a center of an exterior surface of a housing of the charging interface for a small form factor smart wearable according to an implementation of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present invention covers such modifications and variations as come within the scope of the appended claims and their equivalents.

Battery powered electronics devices, such as smart wearable computing devices, that are not self-powered require a charging mechanism, such as a charging interface, that is a component of the device. The charging interface must account for biometric sensors of the wearable computing device, the comfort of wearing the wearable computing device, ingress protection, and hygiene considerations. Additionally, because wearables are intended to be constantly worn, a wearable computing device charging interface should be intuitive (e.g., magnetic and omni-directional), fast, and reliable. Further, it is desirable to establish a “standard” charging interface that can be used on a range of devices to improve the multi-device experience of the user and minimize the impact on the environment. Wearable computing devices vary widely in form factor and there is not a low-profile, intuitive, universal, omni-directional charging interface currently available.

Multi-position magnetic charging interfaces exist, but existing solutions typically include 1-2 defined orientations, are not omnidirectional, and require a recess on the charging interface. This recess can collect non-hygienic detritus, which can hinder charging operations and generally is undesirable. Co-axial multi-pin charging interfaces also exist; however, these charging interfaces are often large, requiring 2-4 pins, and are flat interfaces with locating recesses. The attachment mechanism is often magnetic and may or may not be included as one of the pin contacts. These solutions are not low profile, universal charging solutions across a range of device form facts due to the flat interface and required recesses

Therefore, example aspects of the present disclosure are directed to charging interfaces for wearable computing devices that includes a coaxial arrangement of components on a surface of the wearable computing device.

This arrangement of components enables an omni-directional, wired charging attachment experience. For example, because electrical contracts can be arranged as concentric rings, the electrical contacts can be arranged anywhere on a surface of the charging interface and can align with a charging pad in any direction, instead of being confined to pre-defined axes of alignment due to the location of recessed and/or non-concentric circle contacts.

To maintain contact between the charging interface and the charging pad, and to overcome the spring mating force and other forces, a magnet is housed within the charging interface and used to axially align the charging interface to a charging pad, such as aligning the charging face with the charging pad along an axis around which the concentric ring electrical contacts are located. The magnetic field is designed to concentrate the field strength along the central axis shared by the electrical contact, the magnet, and the aligned charging pad. Natural deviations from this axis due to regular use can be accommodated in the charging pad design.

As a result, the magnetic field serves as the primary alignment mechanism to automatically position the charging interface with respect to a charging pad (e.g., bringing the electrical contacts in contact with the charging pad). The magnet can primarily provide a “featureless” reaction force to overcome the spring contacts and retain the connection between the charging interface and the charging pad. Alignment can then occur along a central axis of the magnetic field. However, one or more side loads can still act to break the charger free from the field. A “self-centering” surface curvature (e.g., the charging interface having a spherical or near-spherical surface) of the charging interface helps to increase the required side load needed to dislodge the charging interface from the charging pad.

Therefore, the charging interface does not require a recess (e.g., a recess in the surface of the charging interface for electrical contacts to contact the charging pad) to align the charging pad along a predetermined axis with the charging interface. This helps to maintain a hygienic, continuous surface of the charging interface that is comfortable on the skin, easy to clean and maintained over time. Furthermore, the surface of the charging interface may be continuous and does not require any recesses. This means detritus cannot gather in recesses, which renders the surface both more hygienic because of the lack of detritus accumulating in the recess.

To enable improved location and universal design across a range of devices, the electrical contact arrangement may be made along the surface of a sphere or near-spherical surface with the spherical axis (or normal surface axis for a near-spherical surface) aligned with a connector axis of the electrical contact, the magnet, and the charging pad. A near-spherical surface is a surface that slightly deviates from a perfectly spherical contour, such as a partially convex contour of a surface. The spherical surface allows for larger surface areas for support and allows the position of the electrical contact to be placed at any position along the sphere, giving broad placement flexibility and combability across a range of devices and device types. For example, to avoid potential magnetic field interference with certain sensors of the wearable computing device, the electrical contacts can be located away from a center position on the charging interface and instead positioned off-center to contact the charging pad away from other sensors that may be contained, for example, on the underside of the wearable computing device along with the charging interface.

The power received through the charging interface from the charging pad can be used to charge a rechargeable battery of the wearable computing device, which in turn provides power to the wearable computing device.

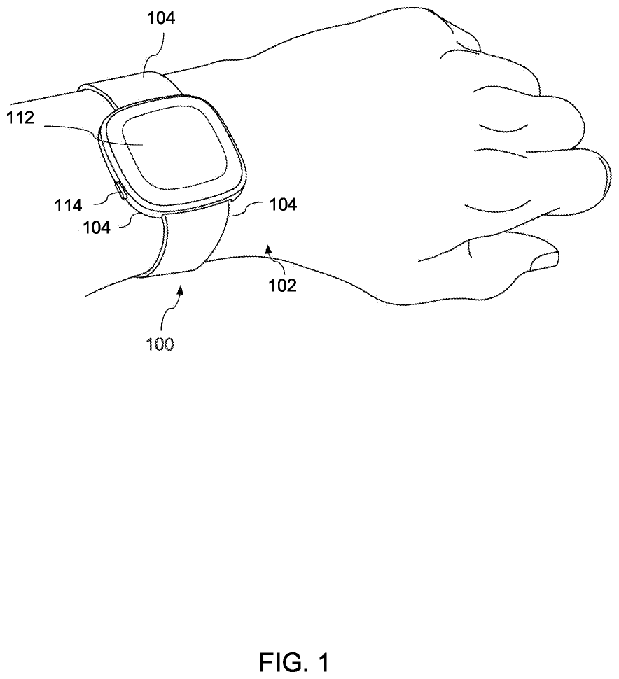

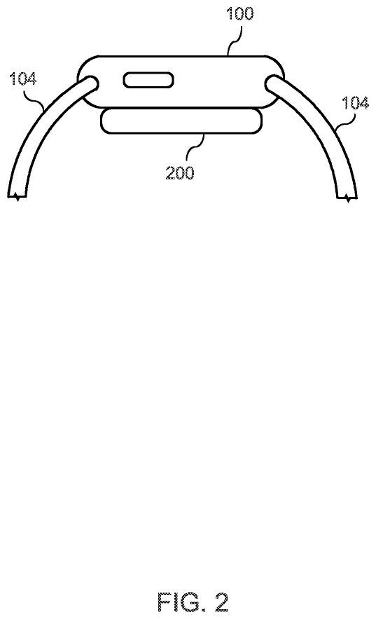

Referring now to the FIGS., FIG. 1 and FIG. 2 depict a wearable computing device 100 according to some implementations of the present disclosure. As shown, the wearable computing device 100 can be worn, for instance, on an arm 102 (e.g., wrist) of a user. For instance, the wearable computing device 100 can include a band 104 and a housing 110. In some implementations, the housing 110 can include a conductive material (e.g., metal). In alternative implementations, the housing 110 can include a non-conductive material (e.g., a plastic material, a ceramic material).

The housing 110 can be coupled to the band 104. In this manner, the band 104 can be fastened to the arm 102 of the user to secure the housing 110 to the arm 102 of the user.

In some implementations, the wearable computing device 100 can include a display screen 112. The display screen 112 can display content (e.g., time, date, biometrics, etc.) for viewing by the user. In some implementations, the display screen 112 can include an interactive display screen (e.g., touchscreen or touch-free screen). In such implementations, the user can interact with the wearable computing device 100 via the display screen 112 to control operation of the wearable computing device 100.

In some implementations, the wearable computing device 100 can include one or more input devices 114 that can be manipulated (e.g., pressed) by the user to interact with the wearable computing device 100. For instance, the one or more input devices 114 can include a mechanical button that can be manipulated (e.g., pressed) to interact with the wearable computing device 100. In some implementations, the one or more input devices 114 can be manipulated to control operation of a backlight (not shown) associated with the display screen 112. It should be understood that the one or more input device 114 can be configured to allow the user to interact with the wearable computing device 100 in any suitable manner. For instance, in some implementations, the one or more input devices 114 can be manipulated by the user to navigate through content (e.g., one or more menu screens) displayed on the display screen 112.

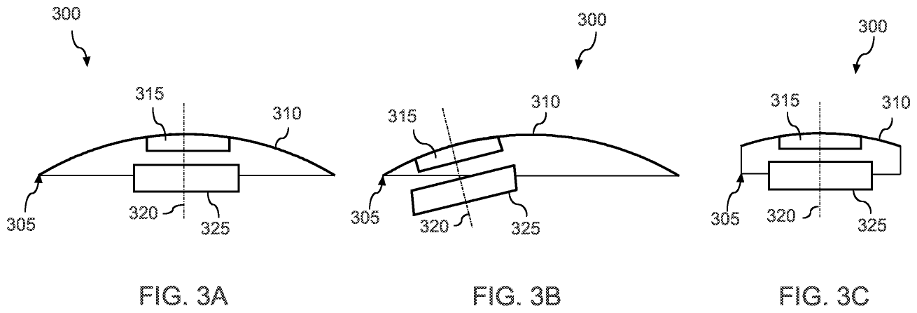

The wearable computing device 100 is charged by interfacing with a charging pad 200. The charging pad 200 can be an inductive charging pad or can be a conductive charging pad for charging a battery of the wearable computing device 100. To receive a charge from the charging pad, the wearable computing device 100 can include a charging interface, such as charging interfaces described with regards to FIGS. 3A-3C, FIGS. 4A-4C, and FIGS. 5A-C as shown below. In some embodiments, the charging interface can be disposed on the underside of the housing 110 (e.g., on a side of the housing 110 that comes into contact with the arm 102 of the user) and is configured to contact the charging pad 200 to receive a charge from the charging pad 200 and charge the battery of the wearable computing device 100.

FIG. 3A depicts a charging interface 300 according to an implementation of the present disclosure. The charging interface 300 includes a housing 305, which has an exterior surface 310. In some embodiments, the housing 305 can include a conductive material (e.g., metal). In alternative implementations, the housing 305 can include a non-conductive material (e.g., a plastic material, a ceramic material). The housing 305 can be coupled to the housing 110 of the wearable computing device 100 or can be a component of the housing 110 of the wearable computing device 100 (e.g., can form one continuous housing as a portion of the housing 110).

In some embodiments, the exterior surface 310 can be a spherical or near-spherical surface (e.g., having no recesses, notches, or other indentations or holes that interrupt the surface).

The charging interface 300 also includes one or more electrical contacts 315 positioned such that the electrical contact(s) 315 are flush (that is, not recessed or elevated) with the exterior surface 310 (e.g., are not recessed or otherwise indented into the exterior surface 310). In this manner, the exterior surface 310 can be a continuous, unbroken surface. The one more electrical contacts 315 include one or more conductors that can receive a charge from an external charging pad, such as charging pad 200, by contacting a corresponding conductor of the external charging pad. In some embodiments, the one or more electrical contacts 315 can be used exclusively for charging the wearable computing device 100. In other embodiments, the one or more electrical contacts 315 can be used for one or more other functions, such as operating both as charging contacts and skin electrodes for monitoring vital signs of a wearer of the wearable computing device 100.

It is advantageous to have the one or more electrical contacts 315 be flush with the exterior surface 310 because, with recessed electrical contacts, detritus can gather in the recess. Making the one or more electrical contacts 315 flush with the exterior surface 310 helps to maintain a hygienic, continuous exterior surface 310 of the charging interface 300 that is comfortable on the skin and can be cleaned and maintained over time. Furthermore, because the surface of the charging interface 300 is continuous and does not require any recesses, detritus cannot gather in recesses, which renders the exterior surface 310 both more hygienic than surfaces that include recesses because of the lack of detritus accumulating in the recess makes the exterior surface 310 easier to clean and maintain over time.

In some embodiments, the one or more electrical contacts 315 can include a plurality of electrical contacts arranged as a group of concentric rings with a common shared center point on the exterior surface 310. For instance, in some embodiments, the common shared center point can be a point along an axis 320 of the charging interface 300. For example, the axis 320 can be the spherical axis of the exterior surface 310 if the exterior surface 310 is spherical in shape. In another example, the axis 320 can be the normal surface axis if the exterior surface 310 is near-spherical in shape.

In some embodiments, axis 320 can be positioned at a center point of the charging interface 300. In other embodiments, axis 320 can be positioned off-center from a center point of the charging interface 300. Because of the spherical or near-spherical nature of the exterior surface 310, the one or more electrical contacts 315 and the axis 320 can be positioned at any point on the exterior surface 310 while still allowing a charge to pass between the one or more electrical contacts 315 and a charging pad the charging interface 300 is coupled to. For example, in FIG. 3B, axis 320 is positioned off-center from a center point of the charging interface 300. By positioning the axis 320 off-center, charging interface 300 can be brought into contact with a charging pad while also keeping sensitive sensors, such as biometric sensors, away from the point of connection between the one or more electrical contacts 315 and the charging pad, as well as allowing for different types and sizes of wearable computing device 100 to use the charging interface 300 to engage with a universal charging pad (e.g., a charging pad meant to interface with any size or type of wearable computing device 100).

The charging interface 300 can also include a magnet 325. The magnet 325 produces a magnetic field, which is used to bring the one or more electrical contacts 315 into alignment and contact with an external charging pad. For example, magnet 325 can be selected such that the magnetic field produced by the magnet 325 concentrates the magnetic field strength along a central axis, such as along axis 320. Natural deviations in from the central axis due to regular use of the charging interface 300 can be accommodated by the design of the external charging pad.

The magnetic field produced by the magnet 325 serves as the primary alignment mechanism for aligning the one or more electrical contacts 315 with the external charging pad and the primary mechanism for retaining contact between the one or more electrical contacts 315 and the external charging pad. In some embodiments, the magnet 325 is disposed within the housing 305 such that the magnet 325 is co-axially aligned with the center point of the one or more electrical contacts 315 along axis 320. In turn, the magnetic field produced by the magnet 325 co-axially aligns the magnet 325, the one or more electrical contacts 315, and the external charging pad. Thus, the one or more electrical contacts 315 can be aligned with contacts of the external charging pad and brought into contact with the contacts of the external charging pad without the need for recesses on the exterior surface 310 of the housing 305, which enables the exterior surface 310 to be a continuous surface that can be kept hygienic (free of detritus), because the exterior surface 310 can be more easily cleaned. Additionally, the wearable computing device can be more comfortable on the user's skin due, at least in part, to the exterior surface 310 of the charging interface 300 being a continuous surface (that is, having no recesses for the electrical contact(s) 315).

The charging interface 300 can fit a variety of wearable computing devices 100 with various form factors. For example, wearable computing device 100 may be a smaller or narrower smart wearable, such as the smart wearable illustrated in FIG. 3C. Even with a smaller form factor to work with on the smaller smart wearable, the charging interface 300 can still be implemented with a continuous spherical or near-spherical exterior surface 310 and have the one or more electrical contacts 315 aligned co-axially along the axis 320 with the magnet 325. Thus, while the form factor of the smart wearable is smaller, the charging interface 300 can still enable the smart wearable to interface with a universal charging pad using the magnet 325 and the one or more electrical contacts 315.

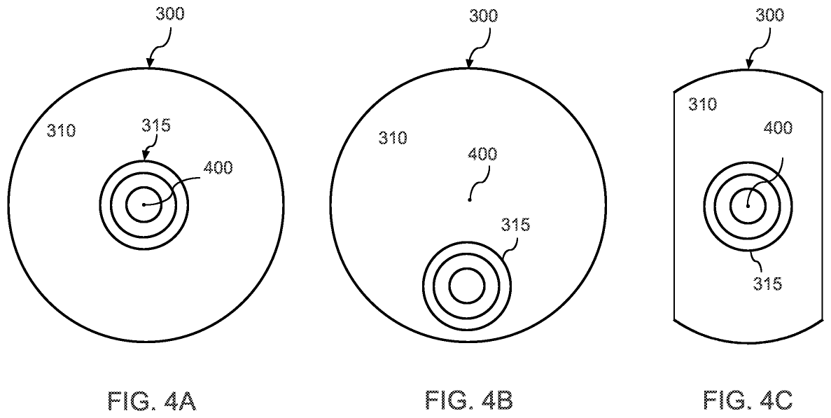

FIG. 4A depicts the one or more electrical contacts 315 of the charging interface 300 positioned at a center point 400 of the exterior surface 310 of the charging interface 300 according to an implementation of the present disclosure. The one or more electrical contacts 315 can include a plurality of concentric ring contacts positioned around the center point 400 of the exterior surface 310, which are co-axially aligned along axis 320 (going through center point 400) with the magnet 325 as shown in FIG. 3A.

FIG. 4B depicts the one or more electrical contacts 315 of the charging interface 300 offset from the center point 400 of the exterior surface 310 of the charging interface 300 according to another implementation of the present disclosure. As shown, the one or more electrical contacts 315 can be positioned closer to a periphery of the exterior surface 310 than in the center of the exterior surface 310. This positioning of the one or more electrical contacts 315 can be advantageous because the housing 105 of the wearable computing device 100 may contain various sensors that are sensitive to magnetic fields, such as biometric sensors, and the positioning of the one or more electrical contacts 315 away from the center of the exterior surface can allow magnet 325 to be used as the primary alignment mechanism for the charging interface 300 and the external charging pad without interfering with these sensors onboard the wearable computing device 100.

FIG. 4C depicts the one or more electrical contacts 315 of the charging interface 300 positioned at the center 400 of the exterior surface 310 of the charging interface 300 for a small form factor smart wearable according to an implementation of the present disclosure. As described above, the one or more electrical contacts 315 can include a plurality of concentric ring contacts positioned around the center point 400 of the exterior surface 310, which are co-axially aligned along axis 320 (going through center point 400) with the magnet 325 as shown in FIG. 3C. In some embodiments, instead of being positioned around the center point 400, the one or more electrical contacts 315 could be positioned near a periphery of the exterior surface 310.

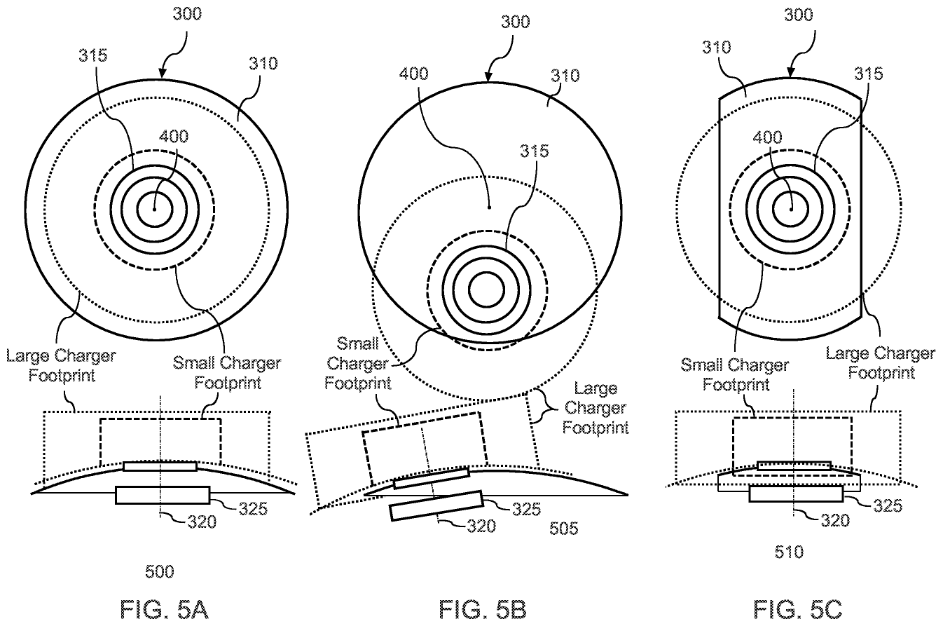

FIGS. 5A-5C depicts charging footprints 500, 505, and 510 for the charging interface 300 according to some implementations of the present disclosure.

Each charging footprint illustrates how different charging pads interface with the charging interface. For example, in FIG. 5A, charging footprint 500 can be associated with a large charging pad that is aligned by magnet 325 along axis 320 at the center point 400 of the exterior surface 310 with the one or more electrical contacts 315 such that the charging pad interfaces the one or more electric contacts 315 with its own electrical contacts and also interfaces with a portion of the exterior surface 310, illustrated by the large charger footprint. A small charging pad can also interface its own electrical contacts with the one or more electrical contacts 315 aligned along the axis 320 at the center point 400 while also interfaces with a smaller portion of the exterior surface 310 as illustrated by the small charger footprint.

In charging footprint 505 illustrated in FIG. 5B, a large charging pad is aligned by magnet 325 along axis 320 with the one or more electrical contacts 315 at a location closer to the periphery of the exterior surface 310. In this instance, a portion of the large charging pad interfaces with a portion of the exterior surface 310 and a second portion of the charging pad does not interface with the exterior surface 310, as shown by the large charger footprint. Similarly, a small charging pad (illustrated by the small charger footprint) has a portion interfacing with the exterior surface 310 and a portion that does not interface with exterior surface 310.

In charging footprint 510 illustrated in FIG. 5C, a smaller form factor wearable computing device and associated charging interface 300 is shown. A portion of a large charging pad can interface with the entirety or a portion close in size to the entirety of the exterior surface 310 (as shown by the large charger footprint) while a smaller charging pad interfaces only with a smaller portion of the exterior surface 310 (as shown by the small charger footprint).

The different charging footprints illustrate the ability of the charging pad to be coupled to the charging interface 300 in a plurality of different configurations. Furthermore, the charging interface 300 can accommodate charging pads of various sizes, because the continuous exterior surface 310 and the placement of the one or more electrical contacts 315 on the exterior surface 310 allows the charging pad to be oriented relative to the charging interface 300 in a plurality of different orientations as show in FIGS. 5A-5C and still be electrically coupled with the one or more electrical contacts 315. This is due, in part, to the placement of the magnet 325 relative to the electrical contacts 315. The different charging footprints also illustrate the cross-compatibility of wearable computing devices having the charging interface 300. As long as the charging interface 300 has the same curvature (e.g., a spherical or near-spherical surface), the mating curvature between the charging pad and the charging interface 300 is the same between any two charging pad-charging interface 300 pairs. Therefore, the charging interface 300 can be used with any charging pad designed to contact the charging interface 300, regardless of the wearable computing device 100 that the charging interface 300 is coupled to.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

It will be understood that when an element is referred to as being “connected” to another element, the expression encompasses an example of a direct connection or direct coupling, as well as a connection or coupling with one or more other elements interposed therebetween.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

1.-21. (canceled)

22. A charging interface for a wearable computing device, the charging interface comprising:
a housing having an exterior surface;
an electrical contact that is flush with the exterior surface;
a magnet disposed within the housing, the magnet co-axially aligned with the electrical contact along an axis, wherein a magnetic field of the magnet is configured to co-axially align an external charging pad with the electrical contact along the axis.

23. The charging interface of claim 22, wherein the electrical contact includes a plurality of conductors arranged as a plurality of concentric rings.

24. The charging interface of claim 23, wherein the plurality of concentric rings have a common center point at the axis.

25. The charging apparatus interface of claim 22, wherein the exterior surface is a spherical surface.

26. The charging interface of claim 22, wherein the axis is normal to the exterior surface.

27. The charging interface of claim 22, wherein the axis connects a center of the magnet with a center of the electrical contact.

28. The charging interface of claim 22, wherein the magnet is co-axially aligned with the electrical contact along the axis and designed such that its magnetic field holds an external charging pad resting against the exterior surface in a charging position with respect to the electrical contact.

29. The charging interface of claim 22, wherein the charging interface is configured to receive power from the external charging pad through the electrical contact, and wherein the charging interface is configured to provide the power to a rechargeable battery of the wearable computing device.

30. The charging interface of claim 22, wherein the electrical contact is disposed at a center of the exterior surface.

31. The charging interface of claim 22, wherein the electrical contact is positioned closer to a periphery of the exterior surface than a center of the exterior surface.

32. A wearable computing device comprising:
a charging interface comprising:
a housing having an exterior surface;
an electrical contact that is flush with the exterior surface;
a magnet disposed within the housing, the magnet co-axially aligned with the electrical contact along an axis, wherein a magnetic field of the magnet is configured to co-axially align an external charging pad with the electrical contact along the axis.

33. The wearable computing device of claim 32, wherein the electrical contact includes a plurality of conductors arranged as a plurality of concentric rings.

34. The wearable computing device of claim 33, wherein the plurality of concentric rings have a common center point at the axis.

35. The wearable computing device of claim 32, wherein the exterior surface is a spherical surface.

36. The wearable computing device of claim 32, wherein the axis is normal to the exterior surface.

37. The wearable computing device of claim 32, wherein the axis connects a center of the magnet with a center of the electrical contact

38. The wearable computing device of claim 32, wherein the magnet is co-axially aligned with the electrical contact along the axis and designed such that its magnetic field holds an external charging pad resting against the exterior surface in a charging position with respect to the electrical contact.

39. The wearable computing device of claim 32, wherein the electrical contact is disposed at a center of the exterior surface.

40. The wearable computing device of claim 32, wherein the electrical contact is positioned closer to a periphery of the exterior surface than a center of the exterior surface.

41. A charging system, comprising the wearable computing device of claim 32, and a charging pad for transferring power to at least one rechargeable battery of the wearable computing device via the charging interface when the wearable computing device is placed at the charging pad.
